(19) United States
(12) Patent Application Publication
(10) Pub. No.: US 2005/0038162 A1
(43) Pub. Date: Feb. 17, 2005

(54) Compositions containing cyclopentadiene adducts and the use thereof for chemically stable coatings

(76) Inventors: Peter Kuhlmann, Wulfrath (DE); Siegfried Krause, Herbern (DE); Andreas Lerschmacher, Dusseldorf (DE); Reinhard Winter, Wulfrath (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/502,769

(22) PCT Filed: Feb. 5, 2003
(86) PCT No.: PCT/EP03/01137

(30) Foreign Application Priority Data
Feb. 7, 2002 (DE) 102 05 065.1

(51) Int. Cl. C08K 5/10

(52) U.S. Cl. 524/315

(57) ABSTRACT

Composition comprising (a) at least one component selected from phenolic resins, amino resins, polyfunctional isocyanates and derivatives thereof, and (b) at least one cyclopentadiene adduct as an additional component obtainable by reacting at least one unsaturated ester product with an optionally substituted cyclopentadiene, wherein the unsaturated ester product is obtainable by reacting an alcohol component, comprising a mono- or polyhydric alcohol, with a carboxylic acid component comprising a mono- or polybasic carboxylic acid or a derivative thereof, with the proviso that the mono- or polyhydric alcohol and/or the mono- or polybasic carboxylic acid comprise at least one non-aromatic double bond and with the proviso that the mono- or polyhydric alcohol is polyhydric and/or the mono- or polybasic carboxylic acid is polybasic, wherein the component (b) comprises functional groups (B) which can enter into a chemical bond with the functional groups (A) of component (a).

The invention relates to compositions containing at least one cyclopentadiene adduct and at least one further component selected from phenolic resins, amino resins, polyfunctional isocyanates and derivatives thereof, as well as coating compositions containing these compositions as binders. The resulting coatings exhibit a high degree of chemical resistance; the coating compositions are therefore suitable as epoxide-free packing lacquers.

The invention furthermore relates to coated articles, particularly containers whose coating can be obtained by applying the coating composition of the present invention.

Coatings with a high degree of chemical resistance are in high demand, among other things for the coating of packaging materials that come into contact with aggressive media. What are referred to as packing lacquers are lacquers for packaging materials made from plastic materials, aluminum and sheet metal, which impart decorative properties to these containers and protect them from their contents; such lacquers are for example used for coating the inside of containers made from tinplate, black plate, chrome-plated steel sheet (TFS=tin-free steel) and sheet aluminum. The containers can for example be tin cans, soda cans, containers for pharmaceuticals (e.g. tubes), aerosol cans, drums and barrels. The interior coating has to exhibit a high degree of chemical resistance (since it is in contact with the contents of the container); depending on the type of packaging it may have to be resistant to sterilization, and in addition, it has to be highly elastic (be expandable and allow flanging) for the manufacture and sealing of the containers. Epoxide-/phenol-based lacquers, which are also referred to as “gold varnishes” due to their self-yellowing during baking, are frequently used, as are pigmented white finishes on the basis of epoxide/melamine resins or polyester/melamine resins.

The reasons why lacquers on the basis of epoxide/phenol are so commonly used are the outstanding properties of these coatings with respect to their processability (paintability, formability), their excellent sensory properties (tasteless and odorless) and the above-mentioned resistance to aggressive media.

It is, however, a considerable drawback that low-molecular components of an epoxide resin based e.g. on bisphenol A are endocrine and can migrate from the coating into the contents of the container; thus, if the content is food, they can end up in the human body.

The effects of endocrine substances have for example been identified in fish—particularly in the run-off of water treatment plants where elevated concentrations of endocrine substances are present. A theoretical adverse effect on human reproductiveness is being discussed.

Replacing these resins with less controversial ones while maintaining their positive properties would therefore be desirable.

As is the case with acrylates, polyester resins in combination with melamine resins are preferably used in lacquers for coating the exterior of containers since their chemical stability is generally insufficient.

Most of the time, the few systems on the basis of polyester phenolic resins which could be considered suitable for interior coating and are commercially available contain polyesters with a very high molecular weight and therefore typically have a rather low solids content of 40 to 60% according to DIN 55671 at a viscosity of 2,000 to 7,000 mPa·s at 25° C. according to DIN 53015, which in the end results in a high price and a high VOC content; at the same time they do not even completely fulfill industry requirements with respect to their resistance properties.

Practical applications demand that container coatings, in particular interior coatings of food containers, exhibit good adhesion, e.g. on the sheet metal used for the container, as well as high resistance to chemicals and sterilization, do not affect taste, smell or appearance of the contents, and have suitable mechanical properties with respect to flexibility and hardness.

Food packaging also has to comply with the regulations of the Food and Drug Administration (FDA) and the U.S. Department of Agriculture (USDA), or the corresponding regulations in other countries (e.g. BGA [Bundesgesundheitsamt, the German Health Department], VGB [the Dutch Food and Health Protection Directorate], Synoptic Document of the Scientific Committee on Food of the Commission of the European Communities, Resolution AP 96(5) of the Council of Europe).

It is therefore the object of the present invention to provide compositions that are free of epoxides and lead to coatings having excellent mechanical properties and chemical resistance which furthermore do not comprise any endocrine components.

Other objects of the present invention are the provision of coating compositions and coated articles, in particular containers, that are suitable for packaging food, whereby the coating compositions leave open a certain latitude regarding the drying parameters, show sufficient storage stability and can be applied by means of conventional application devices.

The objects of the invention are achieved by a composition comprising
(a) at least one component selected from phenolic resins, amino resins, polyfunctional isocyanates and derivatives thereof, and
(b) at least one cyclopentadiene adduct as an additional component obtainable by reacting at least one unsaturated ester product with an optionally substituted cyclopentadiene, wherein the unsaturated ester product is obtainable by reacting an alcohol component, comprising a mono- or polyhydric alcohol, with a carboxylic acid component comprising a mono- or polybasic carboxylic acid or a derivative thereof, with the proviso that the mono- or polyhydric alcohol and/or the mono- or polybasic carboxylic acid comprise at least one non-aromatic double bond and with the proviso that the mono- or polyhydric alcohol has to be polyhydric and/or the mono- or polybasic carboxylic acid has to be polybasic,
wherein the component (b) comprises functional groups (B) which can enter into a chemical bond with the functional groups (A) of component (a),
or a coating composition comprising
(a) the above composition
(b) at least one solvent and
(c) optionally at least one additional component selected from fillers, dyes, pigments and additives such as fungicides, bactericides, drying agents, antiskinning agents, hardening accelerators, flow improvers, emulsifiers, wetting agents, antiflotation agents, antisettling agents and matting agents.

The individual components of the compositions containing cyclopentadiene adducts of the present invention and the coating compositions of the present invention are described in more detail below.

In the following, the term “coating composition” is used in the sense of the term “coating substance” known in the art; the coating substance (coating composition) provides the coating of an article by way of application, drying and optionally baking.

The ester products modified with cyclopentadiene are hereinafter also referred to as cyclopentadiene adducts.

Unless indicated otherwise, the following definitions apply in the present specification: An alkyl group comprises straight-chain and branched hydrocarbon groups with preferably 1 to 20 carbon atoms, especially preferred 1 to 12 carbon atoms; optionally, one or more substituents can be present (preferably one to three) which are independently selected from halogen atoms, OH, SH and NH₂.

Halogen atoms are fluorine, chlorine, bromine and iodine atoms.

An aromatic hydrocarbon group or aryl group as referred to in the following is preferably an aromatic structural unit with 6 to 20 carbon atoms (especially preferred 6 to 12 carbon atoms) optionally comprising one or more substituents (preferably 1 to 3) selected from OH, SH, NH₂, halogen atoms and C₁-C₁₂ alkyl groups. Examples include optionally substituted phenyl and naphthyl groups.

An aliphatic hydrocarbon group is a saturated or unsaturated hydrocarbon group which can be straight-chain or branched and preferably comprises 1 to 30 carbon atoms (especially preferred 1 to 20 carbon atoms). The aliphatic hydrocarbon group can optionally be substituted with one or more substituents (preferably 1 to 3) independently selected from OH, SH, NH₂ and halogen atoms.

A cycloaliphatic hydrocarbon group is a saturated or unsaturated (non-aromatic) hydrocarbon group which preferably comprises 3 to 8 carbon atoms (especially preferred 5 to 6 carbon atoms). The cycloaliphatic hydrocarbon group can optionally be substituted with one or more substituents (preferably 1 to 3) independently selected from OH, SH, NH₂ and halogen atoms and C₁-C₁₂ alkyl groups.

The term “acid derivatives” as used in the following refers to acid anhydrides, acid amides, acid halides and esters, e.g. with aliphatic or cycloaliphatic alcohols or C₇-C₂₀-aralkyl-OH, wherein in the case of esters, C₁-C₁₈ alkyl esters are preferred and C₁-C₆ alkyl esters are especially preferred.

As a first essential component (component (a)), the compositions of the present invention comprise at least one component selected from phenolic resins, amino resins, polyfunctional isocyanates and derivatives thereof, having functional groups (A).

All phenolic resins obtained by the condensation of phenols and carbonyl compounds (e.g. aldehydes such as formaldehyde), the derivatization of the resulting condensate, or the addition of phenols to unsaturated compounds such as e.g. acetyls, terpenes, or natural resins can be used as component (a) of the compositions according to the present invention. Preferred examples include phenol, butylphenol, nonylphenol, cresol, xylenol and bisphenol A resins and derivatives thereof; resols are especially preferred. If necessary, they can be modified in manners known to the person skilled in the art in order to increase their compatibility with the cyclopentadiene adduct; possible modifications include for example etherifications (particularly butylations). A preferred manner of hydrophobing is an etherification of the phenolic resins by introducing hydrophobic groups such as e.g. butyl groups.

Typical commercially available resins which can be used after suitable solvents have been selected taking into account the different polarity of the two components of the composition of the present invention are for example Uravar FB 209 BT-57 (DSM Resins B.V.), Askofen R 9500 (Ashland-Südchemie-Kernfest GmbH), and GPRI 7550 (Georgia Pacific Resins, Inc.).

In addition to phenolic resins, amino resins can also be used as component (a), i.e. polycondensation products of carbonyl compounds (in particular formaldehyde, but also higher aldehydes and ketones) and compounds containing NH groups (e.g. urea, melamine, urethane, cyanamide and dicyanamide, aromatic amines and sulfonamides). Preferred amino resins are melamine and benzoguanamine resins and derivatives thereof, such as e.g. etherified resins (in particular butylated resins) which have the great advantage of being very compatible with other components of coating compositions in general and the cyclopentadiene adducts used as component (b) in particular.

Commercially available resins that can be used in the present invention in combination with the cyclopentadiene adducts include e.g. Cymel 303 (Cytec Netherlands (CRP) B.V.) and Cymel 5011 (Cytec Netherlands (CRP) B.V.).

In addition to phenolic resins and amino resins, polyfunctional isocyanates, in the following also referred to as polyisocyanates, can be used as component (a) as well.

Aliphatic, cycloaliphatic, aromatic and heterocyclic isocyanates with at least two isocyanate groups in one molecule can be used as polyisocyanates. In addition to monomers, oligomers or prepolymers can be used as well. Examples include toluene-2,4-diisocyanate, toluene-2,6-diisocyanate, 3-phenyl-2-ethylene diisocyanate, 1,5-naphthalene diisocyanate, cumene-2,4-diisocyanate, 4-methoxy-1,3-diphenyl diisocyanate, 4-chloro-1,3-phenyl diisocyanate, diphenylmethane-4,4′-diisocyanate, diphenylmethane-2,4′-diisocyanate, diphenylmethane-2,2′-diisocyanate, 4-bromo-1,3-phenyl diisocyanate, 4-ethoxy-1,3-phenyl diisocyanate, 2,4′-diisocyanate diphenylether, 5,6-dimethyl-1,3-phenyl diisocyanate, 2,4-dimethyl-1,3-phenyl diisocyanate, 4,4-diisocyanatodiphenylether, 4,6-dimethyl-1,3-phenyl diisocyanate, 9,10-anthracene diisocyanate, 2,4,6-toluene triisocyanate, 2,4,4′-triisocyanatodiphenylether, 1,4-tetramethylene diisocyanate, 1,6-hexamethylene diisocyanate, 1,10-decamethylene diisocyanate, 1,3-cyclohexylene diisocyanate, 4,4′-methylen-bis(cyclohexylisocyanate), xylene diisocyanate, 1-isocyanato-3-methylisocyanato-3,5,5-trimethylcyclohexane (isophorone diisocyanate), 1,3-bis(isocyanato-1-methylethyl)benzene (m-TMXDI), and 1,4-bis(isocyanate-1-methylethyl)benzene (p-TMXDI).

Blocked polyisocyanates such as e.g. the commercially available Uradur YB147 S1 (DSM Resins B.V.) and DESMODUR BL 3175 (BAYER AG) can be used as well.

As another essential component, the compositions of the present invention comprise at least one cyclopentadiene adduct obtainable by reacting at least one unsaturated ester product and an optionally substituted cyclopentadiene. The ester product in turn is obtainable by reacting an alcohol component, comprising a mono- or polyhydric alcohol, with a carboxylic acid component comprising a mono- or polybasic carboxylic acid. In this reaction, it is important that the mono- or polyhydric alcohol and/or the mono- or polybasic carboxylic acid comprise at least one non-aromatic double bond. Furthermore, the mono- or polyhydric alcohol has to be polyhydric and/or the mono- or polybasic carboxylic acid has to be polybasic.

The resulting cyclopentadiene adduct has to comprise functional groups (B) capable of entering into a chemical bond with the functional groups (A) of the other essential component described above (component (a)).

The cyclopentadiene adducts are obtainable by reacting at least one unsaturated ester product and cyclopentadiene at elevated temperatures (e.g. a temperature of 200 to 300° C., more preferred 240 to 280° C., especially preferred 250 to 280° C.) in a closed system under pressure (e.g. an excess pressure of 0.2 to 15 bar, more preferred an excess pressure of 1 to 10 bar and especially preferred an excess pressure of 3 to 8 bar) whereby an inert solvent can be used. Usually, dicyclopentadiene (optionally substituted) is used for this reaction which, however, breaks down into cyclopentadiene at a temperature of 170 to 180° C. The cyclopentadiene or dicyclopentadiene can optionally comprise one or more substituents independently selected from halogens (fluorine, chlorine, bromine and iodine) and C₁-C₆ alkyl groups. Due to more difficult hydrolysis, these rather low-viscosity—compared with the polyesters mentioned above—cyclopentadiene adducts which have a solids content of more than 70% e.g. in white spirit, measured according to DIN 55671, at a viscosity of about 500 to 3,500 mPa·s (measured at 25° C. according to DIN 53015) have an excellent chemical resistance.

The reactivity of the cyclopentadiene adduct is controlled by the number of functional groups (B) of the cyclopentadiene adducts, i.e. in the end by varying characteristics such as e.g. the hydroxyl number or the acid number.

In addition to hydroxyl groups, basically all nucleophilic groups that can cause chemical cross-linking by reacting with the methylol groups of phenolic resins, amino groups of amino resins, such as e.g. melamine resins or benzoguanamine resins or the isocyanate groups or polyfunctional isocyanates can be functional groups, e.g. the amino or thiol group as well.

A desired side effect of the functional group (B) present in the cyclopentadiene adduct is the reduction of hydrophobicity, which is particularly necessary if phenolic resins are used as a second component since otherwise incompatibilities could ensue in the composition and/or the coating itself.

Cyclopentadiene adducts especially suitable for use in the present invention are e.g. those containing 5 to 60 wt.-% of cyclopentadiene based on the entire adduct in general, preferably 20 to 50 wt.-% and especially preferred 35 to 50 wt.-%. According to a preferred embodiment, the hydroxyl content of the cyclopentadiene adducts is preferably 0.1 wt.-% to 20 wt.-% OH based on the cyclopentadiene adduct, especially preferred 0.5 to 10%, and particularly preferred 1 to 8%.

Naturally, cyclopentadiene adducts are advantageously soluble in non-polar solvents, however, due to the functional groups present in the adducts, which can for example be quantified by characteristics such as the hydroxyl number or acid number, they are to a certain degree also stable in solution in a more polar medium.

For the preparation of the ester product, an alcohol component, comprising a mono- or polyhydric alcohol, and a carboxylic acid component, comprising a mono- or polybasic carboxylic acid, or a derivative thereof are used. For this purpose, the mono- or polyhydric alcohol and the mono- or polybasic carboxylic acid have to be selected such that at least one of them is “polyvalent” and at least one of them comprises at least one non-aromatic double bond.

Furthermore, the functional groups (B) are usually introduced into the cyclopentadiene adduct by preparing the unsaturated ester product accordingly, i.e. the alcohol and acid components are selected appropriately. According to a preferred embodiment, a mono- or polyhydric saturated alcohol and a mono- or polybasic unsaturated carboxylic acid with preferably 1 to 6 non-aromatic double bonds per molecule are used.

It is furthermore preferred that the alcohol component comprise a polyhydric alcohol, and it is then especially preferred that the carboxylic acid component comprise a monobasic carboxylic acid. Polyhydric alcohols with 2 to 6 hydroxyl groups per molecule are particularly preferred.

Mixtures of mono- and/or polyhydric alcohols and/or mixtures of mono- and/or polybasic carboxylic acids or derivatives thereof can be used as well, as long as the prerequisites regarding functionality and non-aromatic double bond are met. It is also possible that one or more of the used alcohols and/or one or more of the used carboxylic acids are present in esterified form. The esterified alcohols and carboxylic acids are preferably triglycerides, but other esters are possible as well.

Examples of suitable mono- or polyhydric alcohols include
monohydric alcohols of the general formula R⁰—OH, wherein R⁰ is a saturated or unsaturated monovalent aliphatic or cycloaliphatic hydrocarbon group, wherein an aliphatic or cycloaliphatic hydrocarbon group optionally comprises one or more ether oxygen atoms and optionally comprises one or more substituents independently selected from halogen atoms, NH₂ and SH,
dihydric alcohols of the general formula HO—R¹—OH, wherein R¹ is a divalent saturated or unsaturated aliphatic or cycloaliphatic hydrocarbon group, which optionally comprises one or more substituents (e.g. 1 to 3) independently selected from halogen, NH₂ and SH, the hydrocarbon group can comprise one or more (preferably no more than four) ether oxygen atoms and preferably comprises two to thirty, especially preferred two to twenty, carbon atoms. The dihydric alcohols are preferably saturated. R¹ is preferably selected from aliphatic C₂-C₁₀ hydrocarbon groups. Examples of such dihydric alcohols include ethylene glycol, diethylene glycol, propylene glycol, dipropylene glycol, butylene glycol, dibutylene glycol and neopentyl glycol,
polyhydric alcohols of the general formula
   HO(CH₂)ₙ—CH₂—CR²OH(CH₂)ₘ—CH₂—(CH₂)ₚOH
wherein n, m and p are independently 0, 1, 2 or 3, and R² is a hydrogen atom, a saturated or unsaturated aliphatic or cycloaliphatic hydrocarbon group with preferably 1 to 12 carbon atoms or a group HO(CH₂)_{q}—, wherein q=0, 1, 2 or 3. The hydrocarbon group can optionally comprise one or more (e.g. 1 to 3) substituents independently selected from halogen, NH₂ and SH. Examples of such polyhydric alcohols include glycerin, trimethylolethane, trimethylolpropane and pentaerythritol,
other polyhydric alcohols such as threitol, erythritol, arabitol, adonitol, xylitol, dipentaerythritol, sorbitol, mannitol and dulcitol, wherein the alcohols optionally comprise one or more substituents independently selected from halogen atoms, SH and NH₂, and
polyhydric alcohols with aromatic rings of the formula R⁵—(R⁶—OH)ₖ, wherein R⁵ is an aromatic hydrocarbon group such as e.g. phenyl or naphthyl which, in addition to k substituents of the formula —(R⁶—OH), optionally comprises one or more additional substituents independently selected from halogen atoms, C₁-C₁₂ alkyl groups, NH₂ and SH, and wherein R⁶ is a saturated or unsaturated aliphatic hydrocarbon group with 1 to 12 carbon atoms and the unit —(R⁶—OH) is bonded to the aromatic 1 to 4 times (i.e. k is an integer from 1 to 4); examples of such alcohols include benzyl alcohol, dimethyloibenzene and trimethylolbenzene.

The mono- or polyhydric alcohol used in the present invention can optionally comprise one or more functional groups selected from SH and NH₂.

Of course, mixtures of mono- or polyhydric alcohols as e.g. mentioned above can be used as well; one or more alcohols can optionally be present in esterified form.

Aliphatic and cycloaliphatic saturated and unsaturated C₂-C₃₀ alcohols (more preferably C₂-C₂₀) as well as C₆-C₃₀ alcohols having aromatic structural units are preferred as mono- or polyhydric alcohols. According to one embodiment, the alcohol component comprises a mono- or polyhydric alcohol without a double bond. According to another embodiment, the alcohol component comprises a polyhydric alcohol. Alcohols having two to six hydroxyl groups per molecule are preferred. It is preferred that saturated polyhydric alcohols be used.

According to one embodiment, the alcohol component consists of a mixture of polyhydric alcohols, one or more of which can be present in esterified form; the alcohols can be esterified with saturated and/or unsaturated carboxylic acids with 1 to 20 carbon atoms and 0 to 6 non-aromatic double bonds.

For preparing the unsaturated ester product, a composition is preferably used wherein the amount of the alcohol component accounts for about 10 to 40 wt.-%, based on the sum of all components used.

The carboxylic acid component can comprise saturated and/or unsaturated aliphatic and/or cycloaliphatic and/or aromatic monocarboxylic acids. They can be used individually or in admixture. Furthermore, mixtures of monocarboxylic acids and polybasic carboxylic acids can be used.

Suitable monocarboxylic acids or also suitable derivatives thereof are for example those of the general formula R³—COOH, wherein R³ is an aryl group optionally substituted with one or more straight-chain or branched alkyl groups with preferably 6 to 10 carbon atoms or a straight-chain or branched saturated or unsaturated aliphatic or cycloaliphatic hydrocarbon group with preferably a total of 4 to 30 carbon atoms, especially preferred 10 to 20 carbon atoms, and optionally one or more substituents independently selected from halogen atoms, NH₂, SH and OH.

Typical examples of saturated carboxylic acids include isodecanoic acid, isooctanoic acid, cyclohexanoic acid and longer-chain carboxylic acids, as well as naturally occurring saturated fatty acids. Palmitic acid and stearic acid are examples of naturally occurring saturated carboxylic acids. However, modifications of natural unsaturated fatty or oleic acids that have been completely hydrogenated technologically are suitable too.

Palmitoleic acid, oleic acid, erucic acid, ricinoleic acid, linoleic acid, linolenic acid, elaeostearic acid, arachidonic acid, clupanodonic acid, docosahexaenoic acid and mixtures thereof can for example be used as unsaturated acids.

Monocarboxylic acids which in addition to the carboxy group comprise a halogen atom, a hydroxyl group, amino group and/or thiol group, as is for example the case in ricinoleic fatty acid, dimethylolpropionic acid or hydrolyzed, epoxidized fatty acids, have to be taken into consideration as well.

Benzoic acid and p-tert.-butylbenzoic acid are typical examples of aromatic carboxylic acids.

Apart from that, the monocarboxylic acids for the preparation of the unsaturated ester product can either be used in the form of the free acid, or amides, halides or anhydrides thereof, or in the form of esters, e.g. with C₁-C₁₈ alkyl alcohols.

Suitable polycarboxylic acids are for example dicarboxylic acids of the general formula HOOC—R⁴—COOH, wherein R⁴ is a divalent group selected from a saturated or unsaturated branched or straight-chain aliphatic or cycloaliphatic group with 0 to 30 carbon atoms (preferably two to six carbon atoms) and an aromatic hydrocarbon group with preferably a total of 6 to 30 carbon atoms optionally substituted with one or more C₁-C₆ alkyl groups. These dicarboxylic acids as well can optionally comprise one or more functional groups selected from hydroxyl groups, amino groups and thiol groups.

Examples include maleic acid, oxalic acid, malonic acid, fumaric acid, succinic acid, terephthalic acid, isophthalic acid, adipic acid, glutaric acid, azelaic acid and o-phthalic acid.

However, polycarboxylic acids of higher functionality, i.e. polycarboxylic acids with more than two (yet preferably no more than six) carboxy groups per molecule, can be used as well.

Examples of polycarboxylic acids of higher functionality include tricarboxylic acids such as trimellitic acid, tricarballylic acid, trimesic acid or hemimellitic acid, tetracarboxylic acids such as pyromellitic acid, or polycarboxylic acids with more than four carboxy groups such as mellitic acid.

Acids which additionally comprise one or more OH groups, amino groups or thiol groups, such as malic acid, tartaric acid, mesotartaric acid, racemic acid or citric acid can also be used as polycarboxylic acids.

For the preparation of the unsaturated ester product, the mono-, di- and polycarboxylic acids can either be used in the form of free acids, or as amides, halides or anhydrides thereof, or in the form of esters (e.g. of straight-chain or branched aliphatic C₁-C₁₈, more preferred C₁-C₆, or cycloaliphatic alcohols, or aralkyl-OH such as e.g. C₆-C₂₀).

According to a preferred embodiment, the unsaturated ester product used for the preparation of the cyclopentadiene adduct is an ester product that is obtainable by reacting an alcohol component comprising a polyhydric saturated or unsaturated alcohol with preferably 2 to 6 hydroxyl groups per molecule with a carboxylic acid component comprising at least 3 wt.-% of long-chain unsaturated acids with 8 to 30 carbon atoms and 1 to 6 non-aromatic double bonds per molecule or derivatives thereof.

The carboxylic acid component used in this embodiment comprises at least 3 wt.-%, preferably at least 20 wt.-%, especially preferred at least 40 wt.-%, of long-chain unsaturated acids with 8 to 30 carbon atoms (preferably 10 to 24, especially preferred 14 to 20 carbon atoms) and 1 to 6 non-aromatic double bonds (preferably 1 to 4) per molecule, or derivatives thereof such as amides, halides, anhydrides and esters, e.g. C₁-C₁₈ alkyl esters. Suitable long-chain unsaturated acids are for example palmitoleic acid, oleic acid, erucic acid, ricinoleic acid, linoleic acid, linolenic acid, elaeostearic acid, arachidonic acid, clupanodonic acid, docosahexaenoic acid and mixtures thereof.

According to an even more preferred embodiment, the unsaturated ester product can be obtained by reacting a drying, semidrying or non-drying oil and a polyhydric alcohol different from glycerin and optionally one or more carboxylic acids (or carboxylic acid derivatives different from triglycerides). The terms drying/semidrying/non-drying oils refer to fatty oils containing unsaturated fatty acids as triglyceride. When exposed to atmospheric oxygen, the (semi)drying oils dry or undergo oxidative curing to form solid, viscoplastic films. The drying capacity depends on the proportion of unsaturated fatty acids in the oil as well as on the number and position of the double bonds; it can be quantified on the basis of the iodine number which for drying oils is generally about>170, and for semidrying oils generally between about 100 and 170. The (semi)drying/non-drying oil is preferably linseed oil, soy oil, sunflower oil, safflower oil, rapeseed oil, cottonseed oil, tall oil, fish oil such as herring oil and whale oil, colza oil, tung oil, dehydrated castor oil, perilla oil, poppyseed oil, nut oil, hempseed oil, whale oil, beechnut oil, corn oil, sesame oil, peanut oil, castor oil, coconut oil, olive oil, palm oil, palm kernel oil, beef tallow, mutton tallow, lard, butter fat or a mixture thereof.

According to one embodiment, a composition is used for the preparation of the unsaturated ester product wherein the amount of monocarboxylic acids is preferably 30 to 95 wt.-%, more preferred 50 to 80 wt.-%, based on the sum of all components used (i.e. alcohols and carboxylic acids).

Due to its unsaturated nature, the preparation of the unsaturated ester product is carried out at lower temperatures than for alkyd resins (usually between 150 and 250° C.) and preferably in the presence of an inert gas (such as e.g. nitrogen or argon) since the reaction of atmospheric oxygen with the double bonds could cause discoloration or even gelatinization.

As is common in resin chemistry, the resulting reaction water is removed by means of azeotropic distillation or with the help of a vacuum.

The stoichiometric ratios are adjusted in a manner known to the person skilled in the art such that unsaturated ester products with acid numbers of preferably 0 to 40 mg KOH/g polymer, especially preferred 1 to 20, and hydroxyl contents of preferably 0.1 to 20 wt.-%, more preferred 0.5 to 10 wt.-%, and particularly preferred 1 to 8 wt.-% OH, based on unsaturated ester product.

The hydroxyl content is for example determined with acetic acid anhydride according to DIN 53240 or ISO 4629. The acid number is measured according to DIN 53402 or ISO 3682.

The compositions containing cyclopentadiene adducts according to the present invention can be used as binders for coating compositions and are especially suitable for packing lacquers. In addition to solvents and the binder on the basis of cyclopentadiene adduct/phenolic or amino resin or polyisocyanate, the coating composition of the present invention can comprise common additional constituents such as dyes, pigments (metal pigments as well as inorganic, organic and organometallic pigments), fillers (e.g. heavy spar, chalk, kaolin etc.) and additives; additives include e.g. fungicides, bactericides, drying agents (e.g. heavy-metal salts of carboxylic acids such as cobalt octoate or lead naphthenate soluble in the binders), antiskinning agents (antioxidants), hardening accelerators (e.g. p-toluene sulfonic acid, phosphoric acid or dodecylbenzene sulfonic acid), flow improvers (e.g. silicone-based), emulsifiers, wetting agents and antiflotation agents (e.g. cationic and non-ionic tensides, silicone oils, aluminum salts of fatty acids or highly disperse silicic acids), wax-based lubricants, antisettling agents and matting agents (e.g. kieselguhr, talcum, synthetically obtained highly disperse silicic acids and polyolefin waxes). It goes without saying that the coating of food containers prepared from the coating composition of the present invention should not contain any harmful substances in order to avoid health hazards. A solvent or solvent mixture is another component of the coating compositions according to the present invention. Examples include hydrocarbons (such as white spirit and xylene), alcohols, e.g. n- or iso-butanol, esters such as e.g. butyl acetate, etherified esters such as methoxybutyl acetate, and ketones such as cyclohexanone.

The coating composition of the present invention preferably comprises 10 to 90 wt.-% of the binder composition of the present invention based on the total weight of the composition, more preferred 30 to 80 wt.-%. Preferably, 0.05 to 10 parts by weight of the second component (i.e. phenolic resin, amino resin, polyisocyanate), more preferred 0.1 to 1 parts by weight, are used per part by weight of cyclopentadiene adduct. The additional components different from solvents are preferably present in a total amount of 0 to 60 wt.-% of the composition, especially preferred 0 to 30 wt.-%.

The preparation of pigmented and unpigmented coating compositions is carried out according to a process comprising the following steps:
(a) providing at least one component selected from phenolic resins, amino resins, polyfunctional isocyanates and derivatives thereof, said component comprising functional groups (A),
(b) preparing an unsaturated ester product as described above,
(c) reacting the unsaturated ester product obtained in step (b) with an optionally substituted cyclopentadiene at room temperature or an elevated temperature resulting in a cyclopentadiene adduct comprising functional groups (B) which can enter into a chemical bond with the functional groups (A) of component (a),
(d) mixing the cyclopentadiene adduct obtained in step (c) with at least one reactant according to (a),
   and optionally
(e) mixing the mixture obtained in step (d) with at least one solvent and optionally one or more additional components selected from dyes, pigments, fillers and additives, whereby one or more components and/or solvents can also already be added to the component provided in step (a) and/or to the cyclopentadiene adduct obtained in step (c).

The preparation of the coating composition comprising the cyclopentadiene adduct of the present invention is carried out by mixing suitable reactants (step (d), above) at room temperature or an elevated temperature, preferably at 60 to 80° C. If the mixing is carried out at elevated temperatures, i.e. if a preliminary reaction takes place between the cyclopentadiene adduct and the suitable reactants, the properties of the corresponding coating may be improved.

Common devices are used for mixing. According to one embodiment, it is also possible to mix the cyclopentadiene adduct (component (b)) and/or the reactant (component (a)) with one or more additional components and/or solvents before the two components are mixed in step (d). Depending on whether additional components and/or solvents are required or not, step (e) is either necessary or can be left out.

Suitable solvents for the coating compositions include e.g. alcohols such as n-butanol and iso-butanol, esters and etherified esters such as 3-methoxy-n-butyl acetate and butyldiglycol acetate, aliphatic hydrocarbons such as white spirit and special boiling-point gasoline 140/165, aromatic hydrocarbons such as diisopropyinaphthalene and mixtures of aromatic hydrocarbons such as Hisol 10® and Hisol 15®. The solvent or solvent mixture best suited for specific components can easily be determined by the person skilled in the art.

The binding compositions comprising at least one component (a) and at least one component (b) usually have a solids content of 2 to 100%, preferably 55 to 85% and are characterized by excellent storage stability when phenolic resins, amino resins or blocked polyisocyanates are used. The coating compositions can be prepared therefrom by adding (additional) solvent(s) and/or additional components. When unblocked polyfunctional isocyanates are used it is preferred, due to their reactivity, that the mixing with the cyclopentadiene adduct does not take place until immediately prior to the application of the coating composition to the article to be coated.

The coating composition of the present invention can be applied to cardboard, wood, glass, plastic materials, as well as metal and metal alloys. It is preferably used for coating metal surfaces such as tinplate, black plate, TFS and sheet aluminum; adhesion is especially good on these surfaces. The coating compositions of the present invention are suitable both as primers and topcoats. The comply with the guidelines of the Food and Drug Administration (FDA) and the U.S. Department of Agriculture (USDA), leave open a certain latitude regarding the drying parameters and show a high storage stability.

The coating compositions of the present invention can be applied by means of conventional equipment; they can for example be sprayed or poured onto the material to be coated, applied with rollers or a doctor blade, or using a dip coating process. The manner of coating is not particularly restricted. Coil-coating and flat sheet coating should be mentioned as particularly suitable coating processes.

In the case of coating compositions according to the present invention comprising phenolic resins, amino resins and/or blocked polyisocyanates, the coating is preferably baked after drying (if the material to be coated allows baking); this is preferably done at about 170° C. to 220° C. and for a time period of about 5 to 30 minutes. If the composition comprises free polyisocyanates, baking is usually not necessary.

A clear and highly lustrous coating with a layer thickness of preferably 2 to 50 μm, more preferred 2 to 20 μm, and particularly preferred 4 to 10 μm, is obtained.

The present invention also relates to articles, in particular containers such as cans, barrels and tanks, having a coating that was prepared by applying the coating composition of the present invention, drying and optionally baking. When preparing containers e.g. from metal it is possible to first form the container and then coat the material or to apply the coating prior to forming. The coating compositions of the present invention are suitable for coating the outside of containers, but due to their chemical resistance, they can also be used for interior coatings.

In addition to containers, other articles such as e.g. crown caps, tops for sealing jars etc., pipes, wires, heat exchangers etc. can also be coated with the coating compositions of the present invention.

The coated articles of the present invention are characterized by a high-gloss clear coating with good adhesion, scratch resistance, a high degree of resistance to chemicals and sterilization; furthermore, in the case of containers, the coating does not affect the taste, smell or appearance of the contents as e.g. foodstuffs. The coatings also exhibit suitable mechanical properties with respect to flexibility and hardness.

The present invention also relates to a kit comprising two containers, wherein the first container comprises component (a) and the second container comprises component (b). In addition, the kit can optionally comprise at least one solvent and/or further components selected from dyes, pigments, fillers and additives, wherein the solvent and/or the additional components can be present in one or more additional containers and/or in the first and/or second container.

The invention will be explained in more detail in the following examples; however, they shall not restrict the invention in any way.

### EXAMPLES

### Example 1

Preparation of Cyclopentadiene Adducts, in Particular Cyclopentadiene-modified Copolymer Resins on the Basis of Drying and Semidrying Oils

Copolymer Resin A

An unsaturated ester product was prepared at 220 to 240° C. in a manner known to the person skilled in the art in connection with polyester or alkyd resins from 21.20 kg soy oil, 4.00 g lithium hydroxide and 0.75 kg pentaerythritol and 0.61 kg phthalic acid anhydride using azeotropic distillation; distillation was carried out until an acid number below 12 was reached. The thus prepared unsaturated ester product was then reacted with 17.30 kg dicyclopentadiene in a pressure-proof reaction vessel at 260 to 280° C., whereby the pressure temporarily reached about 6 bar excess pressure.

The mixture was kept under pressure and at that temperature until 60.00 g of a sample of the reaction mixture mixed with 40.00 white spirit reached a viscosity of 2,000 mPa·s at 25° C. measured according to DIN 53015.

When this viscosity was reached, the reaction was terminated by cooling and reducing the reaction pressure to normal pressure.

While it was still warm, the resin was diluted with 13.50 kg white spirit and then had a solids content of 74.2% (measured according to DIN 55671) and a viscosity of 3,100 mPa·s at 25° C. (measured according to DIN 53015).

Copolymer Resin B

An unsaturated ester product was prepared—as described above for copolymer resin A—from 20.80 kg linseed oil, 4.00 g lithium hydroxide, 1.78 kg pentaerythritol and 1.43 kg phthalic acid anhydride. This unsaturated ester product was then reacted with 12.60 kg dicyclopentadiene, as described above. The reaction was terminated when a mixture of 70.00 g resin sample and 30.00 g white spirit had a viscosity of 1,000 mPa·s (at 25° C.). The resin was diluted with 12.50 kg white spirit which resulted in a solids content according to DIN 55671 of 75.1% and a viscosity of 1,640 mPa·s (at 25° C.) according to DIN 53015.

### Example 2

Preparation of Coating Compositions

2.1. Coating Composition on the Basis of Copolymer Resin A and Phenolic Resin

At room temperature, a solution of 0.65 kg amine-blocked dodecylbenzenesulfonic acid in a mixture of 1.12 kg isopropanol, 0.13 kg water and 13.20 kg diisopropyinaphthalene was added under stirring to 27.00 kg copolymer resin A; then 12.30 kg commercially available phenolic resin A were added. The mixture was diluted with 10.00 kg 3-methoxy-n-butyl acetate, which resulted in a clear 40% solution with high storage stability.

2.2. Coating Composition on the Basis of Copolymer Resin B and Phenolic Resin

As described in 2.1., 27.00 kg copolymer resin B were mixed with 0.50 kg amine-blocked dodecylbenzenesulfonic acid, 1.30 kg isopropyl alcohol, 0.13 kg water, 12.00 kg diisopropyinaphthalene and 13.10 kg phenolic resin B (60% butylated phenolic resin dissolved in n-butanol, molar ratio formaldehyde to phenol=2.5) (60% butylated cresol resin dissolved in n-butanol, molar ratio formaldehyde to cresol=2.5) and diluted with 10.00 kg 3-methoxy-n-butyl acetate. A clear, storage-stable 41% solution was obtained.

2.3. Coating Composition on the Basis of Copolymer Resin A and Amine Resin

Analogously to 2.1., 40.00 kg copolymer resin A were mixed with 0.22 kg amine-blocked dodecylbenzenesulfonic acid, 0.60 kg isopropyl alcohol, 0.06 kg water, 8.00 kg diisopropylnaphthalene and 3.28 kg amine resin A (solvent-free HMMM resin) and diluted with 3.70 kg diisopropyinaphthalene. A clear, storage-stable 60% solution was obtained.

2.4. Coating Composition on the Basis of Copolymer Resin A and a Mixture of a Phenolic Resin and Amine Resin

Analogously to 2.1., 32.00 kg copolymer resin A were mixed with 0.52 kg amine-blocked dodecylbenzenesulfonic acid, 1.35 kg isopropyl alcohol, 0.14 kg water, 14.78 kg diisopropylnaphthalene, 11.27 kg phenolic resin A and 0.68 kg amine resin B (77% butylated benzoguanamine resin dissolved in n-butanol) and diluted with 11.85 kg 3-methoxy-n-butyl acetate. A clear, storage-stable 60% solution was obtained.

2.5. Coating Composition on the Basis of Copolymer Resin A and a Mixture of Phenolic Resin and an Isocyanate Resin

Analogously to 2.1., 27.00 kg copolymer resin A were mixed with 0.65 kg amine-blocked dodecylbenzenesulfonic acid, 1.12 kg isopropanol, 0.13 kg water, 13.20 kg diisopropylnaphthalene, 11.00 kg phenolic resin A and 1.70 kg isocyanate resin (75% blocked aromatic product dissolved in Hisol 10® and having an isocyanate content according to DIN 53185 of 9.6%) and diluted with 10.00 kg 3-methoxy-n-butyl acetate, resulting in a clear 40% solution with high storage stability.

Upon three months of storage at room temperature, the thus produced lacquers showed no signs of change such as phase separation, precipitation or clouding. The properties of coatings prepared from the lacquers that had been stored for three months were in no way inferior in quality compared to coatings prepared from fresh lacquer.

### Example 3

Application and Drying of the Coating Compositions Prepared according to Example 2 on Tinplate

The lacquers were applied onto tinplate by means of 25 μm doctor blades and baked for 15 minutes at 200° C. A golden, clear, scratch-resistant and highly lustrous coating with a layer thickness of 4 to 6 μm was obtained. The coatings showed very good adhesion (Gt=TT=0) and a high resistance to acetone (>100 doublerubs) both before and after having been subjected for 30 minutes at 130° C. to distilled water, 3% acetic acid, 3% sodium chloride solution and 2% urea solution, which caused no change in the appearance of the coatings. Furthermore, the coatings met the industry standards regarding hardness and flexibility.

Positive results were obtained both in practically oriented test methods, such as the sudden bending stress test with a flexural impact tester or the production of cylindrical cups in an Erichsen cupping testing machine, as well as in practical applications such as the production of fish cans or can tops where no crack formation or delamination was observed; the results were at least equally good as, and in some cases superior to, the test results of commercially available and established packing lacquers containing epoxide resins.

1. A composition comprising
(a) at least one component selected from phenolic resins, amino resins, polyfunctional isocyanates and derivatives thereof, and
(b) at least one cyclopentadiene adduct as an additional component obtainable by reacting at least one unsaturated ester product with an optionally substituted cyclopentadiene, wherein the unsaturated ester product is obtainable by reacting an alcohol component, comprising a mono- or polyhydric alcohol, with a carboxylic acid component comprising a mono- or polybasic carboxylic acid or a derivative thereof, with the proviso that the mono- or polyhydric alcohol and/or the mono- or polybasic carboxylic acid comprise at least one non-aromatic double bond and with the proviso that the mono- or polyhydric alcohol is polyhydric and/or the mono- or polybasic carboxylic acid is polybasic,
wherein the component (b) comprises functional groups (B) which can enter into a chemical bond with the functional groups (A) of component (a).

2. A composition according to claim 1, wherein the mono- or polyhydric alcohol does not comprise a non-aromatic double bond and the mono- or polybasic carboxylic acid or a derivative thereof comprises at least one non-aromatic double bond.

3. A composition according to claim 1, wherein the alcohol component comprises a polyhydric alcohol.

4. A component according to claim 3, wherein the carboxylic acid component comprises a monobasic carboxylic acid or a derivative thereof and the alcohol component comprises a polyhydric alcohol.

5. A composition according to claim 3, wherein the polyhydric alcohol comprises two to six hydroxyl groups per molecule.

6. A composition according to claim 1, wherein the unsaturated ester product is obtainable by reacting an alcohol component comprising a polyhydric alcohol with a carboxylic acid component comprising at least 3 wt.-% of long-chain unsaturated acids with 8 to 30 carbon atoms and 1 to 6 non-aromatic double bonds or derivatives thereof.

7. A composition according to claim 1, wherein the mono- or polyhydric alcohol is selected from:
(a) monohydric alcohols of the general formula R⁰—OH, wherein R⁰ is a saturated or unsaturated monovalent aliphatic or cycloaliphatic hydrocarbon group, wherein the aliphatic or cycloaliphatic hydrocarbon group optionally comprises one or more ether oxygen atoms and optionally comprises one or more substituents independently selected from a halogen atom, NH₂ and SH,
(b) dihydric alcohols of the general formula HO—R¹—OH, wherein R¹ is a divalent saturated or unsaturated aliphatic or cycloaliphatic hydrocarbon group, which optionally comprises one or more ether oxygen atoms and optionally comprises one or more substituents independently selected from halogen atoms, SH and NH₂,
(c) polyhydric alcohols of the general formula
HO(CH₂)ₙ—CH₂—CR²OH(CH₂)ₘ—CH₂—(CH₂)ₚOH
wherein n, m and p are independently 0, 1, 2 or 3, and R² is a hydrogen atom, a monovalent saturated or unsaturated aliphatic or cycloaliphatic hydrocarbon group or a group HO(CH₂)_{q}—, wherein q=0, 1, 2 or 3, wherein the aliphatic or cycloaliphatic hydrocarbon group optionally comprises one or more substituents independently selected from halogen atoms, NH₂ and SH,
(d) the group of polyhydric alcohols consisting of threitol, erythritol, arabitol, adonitol, xylitol, pentaerythritol, sorbitol, mannitol and dulcitol, wherein the alcohols optionally comprise one or more substituents selected from SH, a halogen atom and NH₂, and
(e) polyhydric alcohols with aromatic rings of the formula R⁵—(R⁶—OH)ₖ, wherein R⁵ is an aromatic hydrocarbon group which, in addition to k substituents of the formula —(R⁶—OH), optionally comprises one or more additional substituents independently selected from halogen atoms, C₁-C₁₂ alkyl groups, NH₂ and SH, and wherein R⁶ can be the same or different and represents a divalent saturated or unsaturated aliphatic hydrocarbon group with 1 to 12 carbon atoms and k is an integer from 1 to 4.

8. A composition according to claim 3, wherein the polyhydric alcohol is saturated.

9. A composition according to claim 1, wherein the alcohol component consists of a mixture of mono- and/or polyhydric alcohols, one or several of which can optionally be present in esterified form.

10. A composition according to claim 1, wherein the carboxylic acid component consists of a mixture of mono- and/or polybasic carboxylic acids, one or several of which can optionally be present in esterified form.

11. A composition according to claim 6, wherein the unsaturated ester product is obtained by reacting a drying, semidrying or non-drying oil and a polyhydric alcohol and optionally one or more carboxylic acids or carboxylic acid derivatives different from triglycerides.

12. A composition according to claim 11, wherein the polyhydric alcohol is not glycerin.

13. A composition according to claim 6, wherein the carboxylic acid component comprises linseed oil, soy oil, sunflower oil, safflower oil, rapeseed oil, cottonseed oil, tall oil, fish oil, colza oil, tung oil, dehydrated castor oil, perilla oil, poppyseed oil, nut oil, hempseed oil, whale oil, beechnut oil, corn oil, sesame oil, peanut oil, castor oil, coconut oil, olive oil, palm oil, palm kernel oil, beef tallow, mutton tallow, lard, butter fat or a mixture thereof.

14. A composition according to claim 1, wherein the carboxylic acid component comprises at least one carboxylic acid or a derivative thereof selected from:
(a) monocarboxylic acids of the general formula
R³—COOH
wherein R³ is an aryl group optionally substituted with one or more straight-chain and branched alkyl groups or a straight-chain or branched aliphatic or cycloaliphatic saturated or unsaturated hydrocarbon group with optionally one or more substituents selected from halogen atoms, NH₂, SH and OH,
(b) dicarboxylic acids of the general formula
HOOC-R⁴—COOH
wherein R⁴ is a divalent group selected from a branched or straight-chain aliphatic or cycloaliphatic saturated or unsaturated group with 0 to 30 carbon atoms and an aromatic hydrocarbon group optionally substituted with one or more C₁-C₆ alkyl groups,
(c) polycarboxylic acids selected from trimellitic acid, tricarballylic acid, trimesic acid, hemimellitic acid, pyromellitic acid and mellitic acid, and
(d) the group of carboxylic acids consisting of ricinenic acid, sorbic acid, acrylic acid, methacrylic acid and crotonic acid,
wherein one or more of the carboxy groups are optionally not present in a free form, but as an acid amide, acid halide, anhydride or ester and
wherein the at least one carboxylic acid optionally comprises one or more functional groups selected from hydroxyl groups, thiol groups or amino groups.

15. A composition according to claim 6, wherein the long-chain unsaturated acid is selected from palmitoleic acid, oleic acid, erucic acid, ricinoleic acid, linoleic acid, linolenic acid, elaeostearic acid, arachidonic acid, clupanodonic acid, docosahexaenoic acid and mixtures thereof.

16. A composition according to claim 1, wherein the optionally substituted cyclopentadiene is used in the form of the dicyclopentadiene optionally substituted correspondingly and obtained therefrom in situ.

17. A coating composition comprising:
(a) a composition according to claim 1
(b) at least one solvent and
(c) optionally an additional component selected from dyes, pigments, fillers, additives and mixtures thereof.

18. A coating composition according to claim 17, wherein the amount of the composition (a) accounts for 10 to 90 wt.-% based on the coating composition.

19. A method of formulating a lacquer, comprising
a) providing a composition according to claim 1; and
b) diluting said composition to a predetermined solids content to provide a lacquer.

20. The method of claim 19, wherein the lacquer is a packing lacquer.

21. A method of coating articles, comprising applying a coating composition according to claim 17 to an article to be coated.

22. The method of claim 21, wherein the article is a metal article.

23. An article comprising a coating, said coating having been obtained by applying a coating composition according to claim 17, drying, and optionally baking.

24. An article according to claim 23, wherein the article is a container.

25. An article according to claim 24, wherein the container is a can, a barrel or a tank.

26. An article according to claim 23, wherein the article is a metal article.

27. An article according to claim 24, wherein the coating is present at least on the inside of the container.

28. A process for coating a substrate selected from metal, plastic materials, glass, cardboard or wood, comprising applying a coating composition according to claim 17 to the substrate, and drying, the coating on the substrate.

29. A process according to claim 28, wherein the metal is tinplate, black plate, TFS or sheet aluminum.

30. A process according to claim 29, wherein the coating composition is only applied to one side of the plate.

31. A process for manufacturing containers comprising
(a) coating a plate on at least one side according to the process of claim 29,
(b) forming containers from the coated plate obtained in step (a).

32. A process for manufacturing containers comprising
(a) forming the container from metal, a plastic material, glass, cardboard or wood
(b) coating the inside and/or the outside of the container obtained in step (a) according to the process of claim 28.

33. A process for preparing a coating composition according to claim 17 comprising
(a) providing at least one component selected from phenolic resins, amino resins, polyfunctional isocyanates and derivatives thereof, said component comprising functional groups (A),
(b) preparing an unsaturated ester product as described in any of claim 1,
(c) reacting the unsaturated ester product obtained in step (b) with an optionally substituted cyclopentadiene at room temperature or an elevated temperature resulting in a cyclopentadiene adduct comprising functional groups (B) which can enter into a chemical bond with the functional groups (A) of component (a),
(d) mixing the cyclopentadiene adduct obtained in step (c) with at least one reactant according to (a),
and optionally
(e) mixing the mixture obtained in step (d) with at least one solvent and optionally one or more additional components selected from dyes, pigments, fillers and additives, whereby one or more components and/or solvents can also already be added to the component provided in step (a) and/or to the cyclopentadiene adduct obtained in step (c) before the component provided in step (a) and the cyclopentadiene adduct obtained in step (c) are brought into contact.

34. A process according to claim 33, wherein the optionally substituted cyclopentadiene is used in the form of the dicyclopentadiene optionally substituted correspondingly and obtained therefrom in situ.

35. A kit comprising
(i) a first container comprising at least one component (a) selected from phenolic resins, amino resins, polyfunctional isocyanates and derivatives thereof, wherein the component (a) comprises functional groups (A), and
(ii) a second container comprising at least one cyclopentadiene adduct obtainable from the reaction as described in claim 1 and which comprises functional groups (B) which can enter into a chemical bond with the functional groups (A) of the component of the first container.

36. A kit according to claim 35, further comprising at least one solvent and optionally one or more components selected from dyes, pigments, fillers and additives, wherein the solvent and/or the additional components are present in the first and/or second container and/or in one or more additional containers.

37. A process according to claim 28, further comprising the step of baking the coating on the substrate.
